(19) United States
(12) Patent Application Publication
(10) Pub. No.: US 2008/0012794 A1
(43) Pub. Date: Jan. 17, 2008

(54) Non-Rectangular Display Device

(75) Inventor: Stephen J. Battersby, Haywards Heath (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,241

(22) PCT Filed: Jun. 6, 2005
(86) PCT No.: PCT/IB05/51827

§ 371 Date: Dec. 8, 2006

(30) Foreign Application Priority Data
Jun. 9, 2004 (GB) 0412782.5

(51) Int. Cl. G09G 3/20

(52) U.S. Cl. 345/55

(57) ABSTRACT

A non-rectangular display device has a first set of column conductor lines and a second set of column conductor line. The first set of column conductor fines extends straight from an addressing edge of the array of pixels to another edge. The second set of column conductor lines extends between edges of the array of pixels but does not terminating at the addressing edge, as a result of the shape of the display. A column bus extends from one end of each of plurality of the column conductor lines of the second set to the column driver circuit. This column bus provides connection to columns of pixels which do not terminate at the edge of the display, as a result of the shape of the display. This bus can occupy a small space around the periphery of the display, so that design freedom is maximised.

This invention relates to display devices, for example active matrix display devices.

Active matrix displays typically comprise an array of pixels arranged in rows and columns. Each row of pixels shares a row conductor which connects to the gates of the thin film transistors of the pixels in the row. Each column of pixels shares a column conductor, to which pixel drive signals are provided. The signal on the row conductor determines whether the transistor is turned on or off, and when the transistor is turned on, by a high voltage pulse on the row conductor, a signal from the column conductor is allowed to pass on to an area of liquid crystal material (or other capacitive display cell), thereby altering the light transmission characteristics of the material.

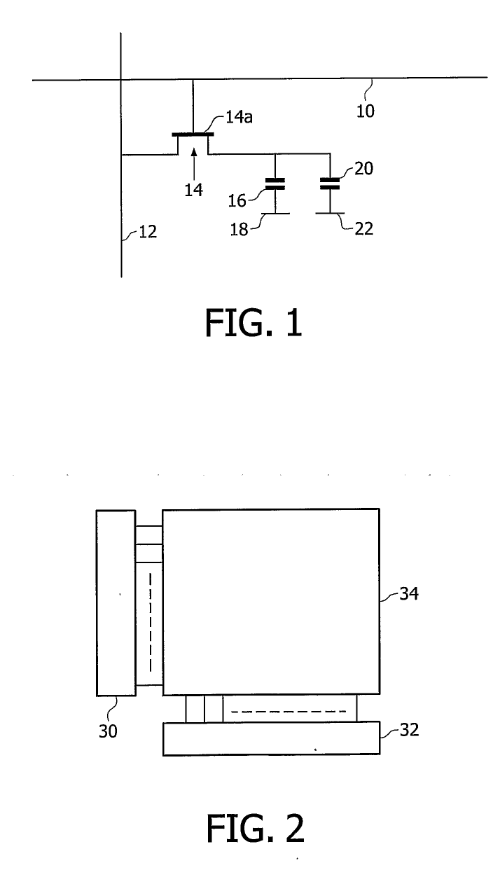

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common electrode 18. The transistor 14 is switched on and off by a signal provided on the row conductor 10. The row conductor 10 is thus connected to the gate 14a of each transistor 14 of the associated row of pixels. Each pixel additionally comprises a storage capacitor 20 which is connected at one end 22 to the next row electrode, to the preceding row electrode, or to a separate capacitor electrode. This capacitor 20 stores a drive voltage so that a signal is maintained across the liquid crystal cell 16 even after the transistor 14 has been turned off.

In order to drive the liquid crystal cell 16 to a desired voltage to obtain a required gray level, an appropriate signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and the storage capacitor 20 maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance.

The rows are addressed sequentially so that all rows are addressed in one frame period, and refreshed in subsequent frame periods.

As shown in FIG. 2, the row address signals are provided by row driver circuitry 30, and the pixel drive signals are provided by column address circuitry 32, to the array 34 of display pixels.

Displays are conventionally rectangular in shape, and this enables all pixels in the display to be addressed using a single row driver circuit and a single column address circuit, as shown in FIG. 2. However, designers now wish to incorporate non-rectangular displays into product designs, and this requires modification to the arrangement of the row and column driver circuits. In particular, a narrow border is desired around the outside of the non-rectangular display area.

There are a number of difficulties in producing a non-rectangular display, including issues concerning cutting out the shape, providing uniform backlighting and generating appropriate image content. This invention is concerned with problems in providing row and column address signals to such displays.

WO 93/04460 discloses a display which has a circular display area over a square mounting substrate. The row and column driver circuits are mounted in the corners of the square, so that the display area is maximised for a given square substrate. There are two row driver circuits and two column driver circuits arranged in alternating order in the four corners of the substrate.

According to the invention, there is provided a display device comprising an array of pixels arranged in rows and columns, each pixel being addressed by a row driver circuit and a column driver circuit which connect to respective row and column conductor lines within the pixel array, the column driver circuit being provided adjacent one edge region of the array of pixels, the one edge region corresponding substantially in length to the length of the row of pixels closest to the column driver circuit, and wherein the column conductor lines comprise a first set of column conductor lines and a second set of column conductor lines, the first set of column conductor lines extending straight from the one edge region of the array to another edge of the array of pixels, the second set of column conductor lines extending between edges of the array of pixels and not reaching the first or last row of pixels and thereby not terminating at the one edge region, and wherein the device further comprises at least one column bus, the column bus comprising a plurality of conductor lines extending from one end of each of plurality of the column conductor lines of the second set to the column driver circuit.

In this arrangement, a column bus is used to provide connection to columns of pixels which do not terminate at the edge of the display, as a result of the shape of the display. This bus can occupy a small space around the periphery of the display, so that design freedom is maximised.

The column bus may substantially follow the outer shape of the pixel array to the column driver circuit.

Preferably, the conductor lines of the column bus are spaced more closely than the column conductor lines. Indeed the spacing between the conductor lines of the column bus may be approximately equal to their width. A very narrow space outside the pixel array is thus taken up.

The one edge of the display may be narrower than the maximum dimension of the display parallel to the one edge. The invention thus enables pixel connections to be made for displays where an available edge is not wide enough for a full set of array (row or column) conductors.

The outer shape of the display may also have at least one recess portion which divides at least one column of pixels into pixels connected to a column conductor line of the first set and pixels connected to a column conductor line of the second set. Thus, the invention enables pixel connections to be made for displays with discontinuous columns of pixels.

Preferably, the one edge is straight.

The row driver circuit may also be provided adjacent the one edge, and in this case each row conductor line can comprise a spur which runs in the column direction. This is a so-called “parallel drive” scheme and enables a single available straight edge to be used as the location for both the row and column driver circuitry.

The spurs for all the row conductor lines may extend to the one edge, but this is not essential. For example, the spurs for a first set of the row conductor lines may extend to the one edge, and the spurs for a second set of the row conductor lines extend to an edge of the array which is not the one edge. In this case, the column bus also connects the spurs for the second set to the column driver circuit. In this case, the row and column driver circuits comprise a single integrated circuit.

Instead, of the parallel drive scheme, a row bus may be used to link the row conductors to row driver circuitry located which is also located at the one edge. Thus all row and column connections can be made to circuitry located adjacent the one edge of the display.

The connections between the ends of the first set of column conductor lines at the one edge and the column driver circuit may include fan-out regions.

Examples of the invention will now be described in detail with reference to the accompanying drawings, in which:

FIG. 1 shows one example of a known pixel configuration for an active matrix liquid crystal display;

FIG. 2 shows a display device including row and column driver circuitry;

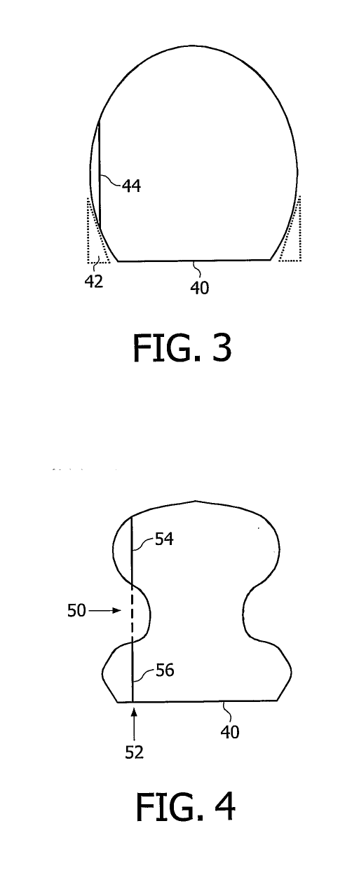

FIG. 3 shows a first example of display shape for which the invention is suitable;

FIG. 4 shows a second example of display shape for which the invention is suitable;

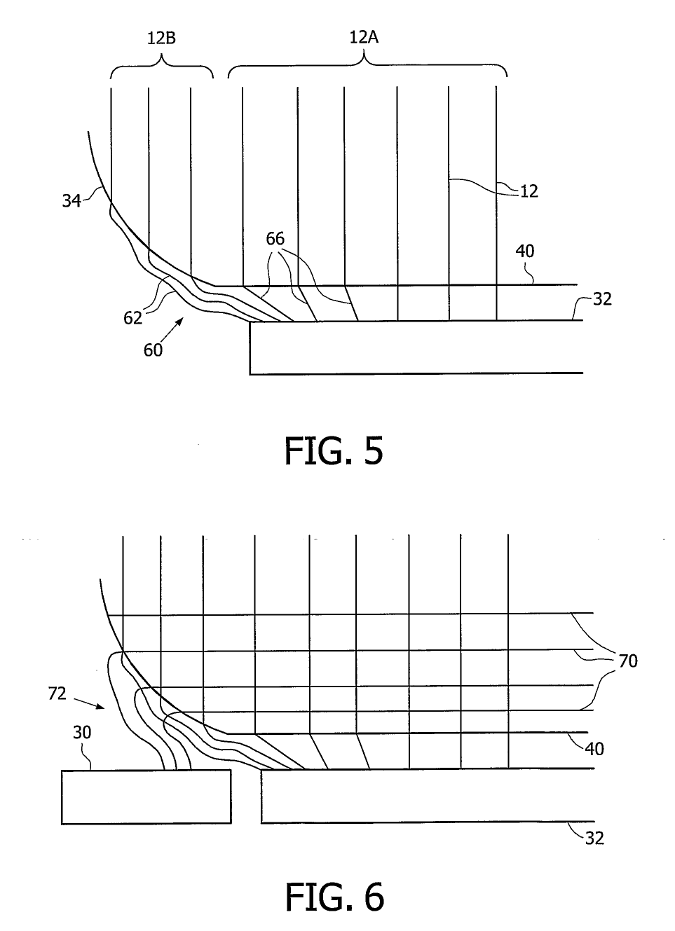

FIG. 5 shows a first display device of the invention;

FIG. 6 shows a second display device of the invention;

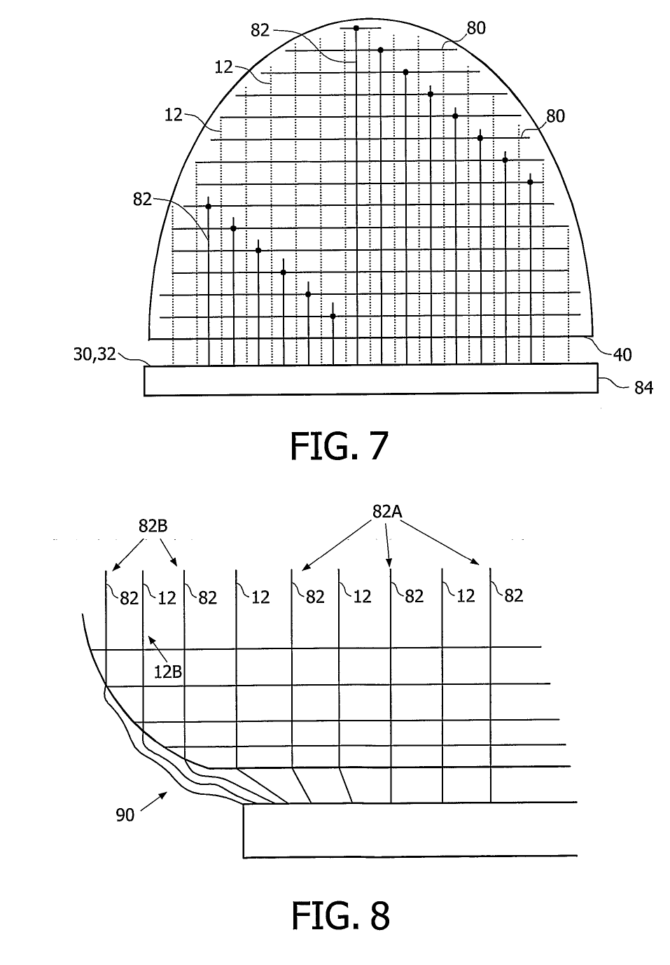

FIG. 7 is used to explain the principle of parallel drive; and

FIG. 8 shows a third display device of the invention.

This invention relates to the addressing of non-rectangular displays using an array of row and column conductors. Some non-rectangular shapes pose more of a difficulty than others. Essentially, the rows and columns must be continuous and cover the full display area. If the widest part of the display shape occurs at one edge, then this edge can be used for providing the termination of the row or column conductors and they cover the full width of the display. Provided the display shape has no recesses in its outer shape, then the full display area can be reached by the columns which each terminate at the one edge, as required. In this case, the arrangement of the row and column addressing circuitry is relatively straightforward.

If the shape does have recesses in its outer shape (the significance of this will become clearer below) or if an edge does not provide the widest part of the display, then difficulties can arise. This invention concerns displays having shapes presenting these types of difficulty.

FIG. 3 shows a display shape in which an edge 40 does not provide the widest part of the display. In this case, column conductors such as 44 for the widest parts of the display will terminate before the location of the integrated circuit. The substrate may have been removed from the corners, shown in dotted lines as 42, so that there is no possibility of simply extending the column conductors.

FIG. 4 shows a display shape in which sides of the display also have re-entrant portions 50. This means that a column of pixels is discontinuous. For example, column 52 comprises separate portions 54,56. The edge 40 also does not cover the widest part of the display in this example.

FIG. 5 shows a first display device of the invention.

For simplicity, the invention is explained with reference to column conductors and column driver circuits. Thus, FIG. 5 shows a column driver circuit 32 which connects to respective column conductor lines 12. The column driver circuit is provided adjacent one edge 40 (which is straight in FIG. 5) of the array 34 of pixels. FIG. 5 shows a part of the display near to the column driver circuit 32 for the display shape of FIG. 3.

This display shape gives rise to a first set of column conductor lines 12A extending straight from the edge 40 of the array to an opposite top (curved) edge of the array of pixels. A second set of column conductor lines 12B extend between edges of the array of pixels and not terminating at either end at the edge 40. Thus, the second set of column conductor lines 12B are in the part of the display which overhangs the narrower edge 40. For the display shape of FIG. 4, the column sections 54 do not terminate at either end at the edge. Thus, the second set of column conductors 12B also includes column is sections where a re-entrant outer shape has formed a discontinuity in a column of pixels.

A column bus 60 is provided and comprises a plurality of conductor lines 62 extending from one end of the column conductor lines of the second set 12B to the column driver circuit 32. A column bus will be provided on each side for the symmetrical shape of FIG. 3 or 4.

The column bus 60 follows the outside of pixel array 34 to the column driver circuit 32 so that the additional space needed outside the pixel array is minimised. The conductor lines 62 of the column bus 60 can be spaced much more closely than the column conductor lines (i.e. the pixel spacing). A typical pixel pitch is 150 μm-200 μm and a typical conductor width is 6 μm. The spacing between the conductor lines may be approximately equal to their width, namely approximately 6 μm. A very narrow space outside the pixel array is thus required, and this enables the greatest freedom of design for the end product.

FIG. 5 also shows the connections between the ends of the first set 12A of column conductor lines and the column driver circuit 32 including fan-out regions 66 at the outermost ends, as is conventional in the art.

The connection of the rows to the row driver circuitry is not shown above. In the display shapes shown, the rows are all continuous and row circuitry on either side of the display can provide connections for all row conductors. The row driver circuitry can be provided as a number of row driver chips, and this can enable the row driver circuits to follow the outer shape of the display, for example with fan-out connections from each row driver chip to the respective row ends.

The connections to the rows can be done in several different ways. One way is to mount row driver ICs on a different edge as described above, with connections to the rows using a fan-out. Another (for Low Temperature Polysilicon) is to integrate the row driver either inside or outside the column bus. A further alternative is to locate the row driver close to the column driver, so that only one portion of the periphery of the display is significantly larger than the viewing area itself. This requires a row bus to join the rows to the row driver, and the row and column buses could then be separate or interleaved.

FIG. 6 shows a variation in which a row bus us used to take connections from all of the row ends and route these to row driver circuitry at the top or bottom of the display. In FIG. 6, row conductors 70 connect through bus 72 to row driver circuitry 30. Only three connections to the row conductors 70 are shown for clarity. Thus, a column bus and a row bus may be used to make sure that all row and column connections can be made to circuitry located adjacent the one edge of the display. The row and column driver circuitry could also be in a single integrated circuit.

In one possible alternative implementation, a so-called “parallel drive” scheme may be employed, and this is explained with reference to FIG. 7.

Each row conductor line 80 comprises a spur 82 which runs in the column direction. These spurs are interleaved with the column conductors 12 and extend to the edge 40 where the column driver circuit 32 is provided. This enables a single available straight edge to be used as the location for both the row and column driver circuitry, and they can then be integrated into one integrated circuit 84.

The spurs 82 for all the row conductor lines may extend to the one edge as shown in FIG. 7, but this is not essential.

FIG. 8 shows alternating spurs 82 and column conductors 12. The spurs 82A for a first set of the row conductor lines extend to the one edge, but the spurs 82B for a second set of the row conductor lines do not. In this case, the bus 90 provides a connection of the spurs of the set 82B and the column conductors of the set 12B to the address circuitry, which in this case is integrated row and column address circuitry. In this case, the interleaving of the rows and columns in the array means that the row and column buses are also interleaved.

When the invention is applied to the display shape of FIG. 4, the column conductor section 54,56 can be connected together by a bus which simply bridges the recess 50, and the column bus to the column driver circuitry is then only for column outside the width covered by the edge 40. The bus bridging the recess will again follow the outer shape of the recess. Alternatively, the column conductor sections 54 can be connected by the column bus to the column driver circuit.

The row and column driver circuits may be formed on the same substrate as the display pixels, for example the pixels and driver circuitry may be formed using polysilicon processing technology. Alternatively, the driver circuit portions may be on a different substrate or substrates to the display area. They may comprise discrete chips which connect to an amorphous silicon display substrate.

The terms “row” and “column” are somewhat arbitrary in the description and claims. These terms are intended to clarify that there is an array of elements with orthogonal lines of elements sharing common connections. Although a row is normally considered to run from side to side of a display and a column to run from top to bottom, the use of these terms is not intended to be limiting in this respect.

The invention can be applied to any type of display which provides pixels and intersection of orthogonal conductors. Thus, the invention may be applied to electroluminescent as well as liquid crystal displays.

Other features of the invention will be apparent to those skilled in the art.

1. A display device comprising an array of pixels arranged in rows and columns, each pixel being addressed by a row driver circuit (30) and a column driver circuit (32) which connect to respective row (70) and column (12) conductor lines within the pixel array, the column driver circuit (32) being provided adjacent one edge region (40) of the array of pixels, the one edge region (40) corresponding substantially in length to the length of the row of pixels closest to the column driver circuit (32), and wherein the column conductor lines (12) comprise a first set (12A) of column conductor lines and a second set (12B) of column conductor lines, the first set (12A) of column conductor lines extending straight from the one edge region (40) of the array to another edge of the array of pixels, the second set (12B) of column conductor lines extending between edges of the array of pixels and not reaching the first or last row of pixels and thereby not terminating at the one edge region (40), and wherein the device further comprises at least one column bus (60), the column bus (60) comprising a plurality of conductor lines (62) extending from one end of a plurality of the column conductor lines of the second set (12B) to the column driver circuit (32).

2. A device as claimed in claim 1, wherein the column bus (60) substantially follows the outer shape of the display to the column driver circuit (32).

3. A device as claimed in claim 1, wherein the conductor lines (62) of the column bus (60) are spaced more closely than the column conductor lines.

4. A device as claimed in claim 1, wherein the one edge region (40) of the display is narrower than the maximum dimension of the display parallel to the one edge region.

5. A device as claimed in claim 1, wherein the outer shape of the display has recess portions (50) which divide at least one column of pixels into pixels connected to a column conductor line (56) of the first set and pixels connected to a column conductor line (54) of the second set.

6. A device as claimed in claim 1, wherein the one edge region (40) is straight.

7. A device as claimed in claim 1, wherein the row driver circuit (30) is provided adjacent the one edge region (40), and wherein each row conductor line comprises a spur (82) which runs in the column direction.

8. A device as claimed in claim 7, wherein the spurs for all the row conductor lines extend to the one edge.

9. A device as claimed in claim 8, wherein the spurs (82A) for a first set of the row conductor lines extend to the one edge region (40), and the spurs (82B) for a second set of the row conductor lines extend to an edge of the array which is not the one edge region (40), wherein the column bus (90) also connects the spurs (82B) for the second set to the column driver circuit, and wherein the row and column driver circuits comprise a single integrated circuit (84).

10. A device as claimed in claim 1, wherein the device further comprises at least one row bus (72), the row bus comprising a plurality of conductor lines extending from one end of each of a plurality of row conductor lines to the row driver circuit.

11. A device as claimed in claim 1, wherein the row and column driver circuits comprise a single integrated circuit (84).

12. A device as claimed in claim 1, wherein the connections between the ends of the first set (12A) of column conductor lines (12) at the one edge region (40) and the column driver circuit (32) include fan-out regions (66).
